(19) United States
(12) Patent Application Publication
(10) Pub. No.: US 2008/0302920 A1
(43) Pub. Date: Dec. 11, 2008

(54) Aerial Lifting and Propulsion Device (ALPD)

(76) Inventor: Gerald L. Mack, Fuquay Varina, NC (US)

Correspondence Address: Gerald L. Mack, 5717 Brushy Meadow Dr., Fuquay Varina, NC, 27526, US

(21) Appl. No.: 11/714,789

(22) Filed: Mar. 7, 2007

(51) Int. Cl. B64C 39/00

(52) U.S. Cl. 244/23 R

(57) ABSTRACT

This invention, an Aerial Lifting and Propulsion Device, introduces an aircraft and aircraft wing design that has an outer and inner circumference, both of which are employed in the entirety of each to evacuate air, air space, and/or atmosphere from above the circular wing/craft, to the area beneath the circular wing/craft, through the use of a propeller inside the inner circumference of the circular wing, and impellers at the outer circumference of the circular wing. When the air, air space, and/or atmosphere forced from above the circular wing into the area beneath the circular wing and propeller attempts to escape to the top of the circular wing to fill the newly created low pressure area above the circular wing, it is intercepted at the lower edge of the outer circumference of the circular wing and forced to returned to the area beneath the circular wing, where the atmospheric pressure is further increased or decreased at will, depending on the pitch and speed of the aircraft propeller and impeller blades. The noted reduced atmospheric pressure at the top of the circular wing, and the higher controlled atmospheric pressure in the area beneath the circular wing and propeller, forces the circular wing upward from its stationary position, achieving lift as described in Bernoulli's Principle. Stabilization and directional control is maintained through adjustments in the pitch of the impeller and propeller and the effects of torque are neutralized by the rotation of the impeller and propeller assemblies in opposite directions. The Aerial Lifting and Propulsion Device maintains its upright configuration while airborne in part because its center of gravity is well below the points where lift is generated.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND OF THE INVENTION

This invention is an outgrowth of my research regarding concepts for creating lift from a stationary platform in a manner that is consistent with natural laws embodied in Bernoulli's Principle and certain of Newton's Laws. Presently, all aircraft rely on lift generated by the forward motion of wings or the rotational motion of propeller blades (similar to wings), except for rocket powered and lighter than air crafts. This invention provides a new means to mechanically create and control lift, from a stationary point, while exercising control of all air, airspace, and/or atmosphere that is in contact with the entire surface of the aircraft, including regulation of atmospheric pressure above and below the aircraft and its wing(s), at will, consistent with the natural laws embodied in Bernoulli's Principle, which accounts for 100% of lift. This invention also introduces and claims a new wing design that is integral to the exercise of control over natural elements of atmosphere and laws of nature that permit generation and control of lift, and further, control of the same aircraft once it is airborne. Also notable is that all moving parts of the aircraft are inside the exterior fixed planes of the aircraft.

While a wide range of operational winged and rotary aircraft effectively generate lift through forward motion and the use of rotor blades, and others use thrust and lighter than air features, none of the existing methodologies teach or incorporate features of the air vehicle disclosed and claimed in this application for patent(s). This invention as a simple, low altitude or high altitude aircraft has practical applications in all areas of the transportation and defense industry.

### BRIEF SUMMARY OF THE INVENTION

This invention, the Aerial Lifting and Propulsion Device (ALPD), hereafter referred to in this application for patent as the ALPD, re-creates, around a stationary object, conditions that exists around the wings of a conventional aircraft when the conventional aircraft reaches it lift off speed and the body of the aircraft rotates to a nose up tail down configuration, increasing the angle of attack for the aircraft wings, creating lift that causes the wings, and the attached body of the aircraft, to ascend from its runway or take off area. For conventional rotary aircraft, these conditions are identical for each rotor on the rotary aircraft, each of which, at an appropriate speed of rotation, with increased pitch, directly supports its portion of the weight/load lifted by the rotors as the rotors rise when the angle of attack and/or speed of rotation increase. These conditions are described in natural laws embodied in the language of Bernoulli's Principle and Newton's Laws of Physics.

Lift achieved through linear movement of wings does not involve direct control of the airspace around the wing(s), or the body of the winged craft, to achieve lift, but instead, aircraft is generated by controlling air, airspace, and/or atmospheric pressure directly above each rotor on the rotary aircraft, and, like fix winged aircraft, through adjustments in the speed and pitch of each rotor. However, once air, airspace, and/or atmosphere, has been moved to the lower surface of the rotor blade(s), the air, air space, and/or atmosphere are not further controlled, and moves quickly to re-fill the area of reduced atmospheric pressure created above each rotor, that made lift possible.

This invention introduces an aircraft and aircraft wing design that has an outer and inner circumference, both of which are employed in the entirety of each to evacuate air, air space, and/or atmosphere from above the circular wing/craft, to the area beneath the circular wing/craft, through the use of a propeller inside the inner circumference of the circular wing, and impellers at the outer circumference of the circular wing. When the air, air space, and/or atmosphere forced from above the circular wing, by the propeller, through 100% of the inner wing circumference, into the area beneath the circular wing/craft, and attempts to escape to the top of the circular wing/craft to fill the newly created low pressure area above the circular wing/craft, it is intercepted at the lower edge of the outer circumference of the circular wing/craft and returned to the area beneath the circular wing/craft, where the atmospheric pressure is further increased or decreased at will, depending on the pitch and speed of the aircraft propeller and impeller blades. The noted reduced atmospheric pressure at the top of the circular wing, and the higher controlled atmospheric pressure in the area beneath the circular wing/craft, forces the circular wing/craft upward from its stationary position as described in Bernoulli's Principle.

### BRIEF DESCRIPTION OF THE SEVERAL VIEWS OF THE DRAWING

FIG. 1 Air Flow Diagram—Helicopter Rotor

FIG. 2 O Wing

FIG. 3 Air Flow Diagram—Helicopter Rotor with O Wing

FIG. 4 Air Flow Diagram—Helicopter Rotor with O Wing and Impeller Assembly

FIG. 5 ALDP Propeller Assembly

FIG. 6 ALPD Impeller Assembly

FIG. 7 Parts List Diagram

FIG. 8 ALPD Stabilization Platforms

FIG. 9 Engine I and Impeller Gear and Shaft Assembly

FIG. 10 Impeller Assembly Mounted

FIG. 11 Vertical Propeller Shaft Assembly

FIG. 12 O Wing Lower Impeller Intake Opening Frame Assembly

FIG. 13 O Wing Upper Impeller Intake Opening Frame Assembly

FIG. 14 O Wing

FIG. 15 O Wing Installed

FIG. 16 Top View of ALPD

FIG. 17 Three Dimensional View of ALPD

### DETAILED DESCRIPTION OF THE INVENTION

On Mar. 8, 2006, through the Law Offices of Fleishner and Kim, L.L.P., Registration Number 38128, I filed a Provisional Patent on the invention for which I am now seeking a Non Provisional Utility Patent in this application for a patent. The details of the Provisional Patent are as follows: Provisional Application; Docket Number GLM-0001PR; Inventor/Applicant: Mack, Gerald L; Residence: Centreville, Va.; Date Filed: Mar. 8, 2006; and Title of Invention: Aerial Lifting and Propulsion Device (ALPD).

The first claim of this invention is that the atmospheric conditions that create lift in a winged or rotary aircraft can be created around a stationary object, body or wing, hereafter referred to as a wing, by changing the configuration of the wing to be lifted, and any attachments, so that the wing has an inner and outer circumference. This means the wing configuration must be changed from the traditional rectangular, triangular or other configuration to a wing configuration that is round with a hollow center. This configuration allows for positive control of all air, airspace, air flow, atmosphere, and atmospheric pressure in the immediate area of as well as above, below, and on all sides of the wing. By controlling all air, airspace, air flow, and atmosphere, on all exterior surfaces of the wing, atmospheric pressure can be regulated above and below the wing, increasing and decreasing lift at will, from a stationary point and while in flight.

In FIG. 1, examination of arrows that represent the direction of air flow as a helicopter like rotor turns with a positive angle of attack clearly demonstrates that as the air, air flow or atmosphere is moved to the area beneath the rotor blades by rotor blade rotation and increased positive pitch, the same air or atmosphere moves out and upward, around the outer edges of the rotation field, to fill the low pressure are above the rotor blades (depicted by the parallel broken lines above the rotation field) created by the rotation of the rotors as the rotors force air/atmosphere downward. Sufficient lift can be generated in this manner as is evidenced by the operation of conventional rotary aircraft. Lift generated in this manner if highly inefficient and power intensive. As noted, the rotor rotation and pitch must be sufficient to overcome the unimpeded movement of air out and upward to fill the low pressure area created by the same rotors. Notably, the faster the rotation and the greater the blade pitch, proportional increases are noted to occur in the speed of air to fill the low pressure area above the rotation field.

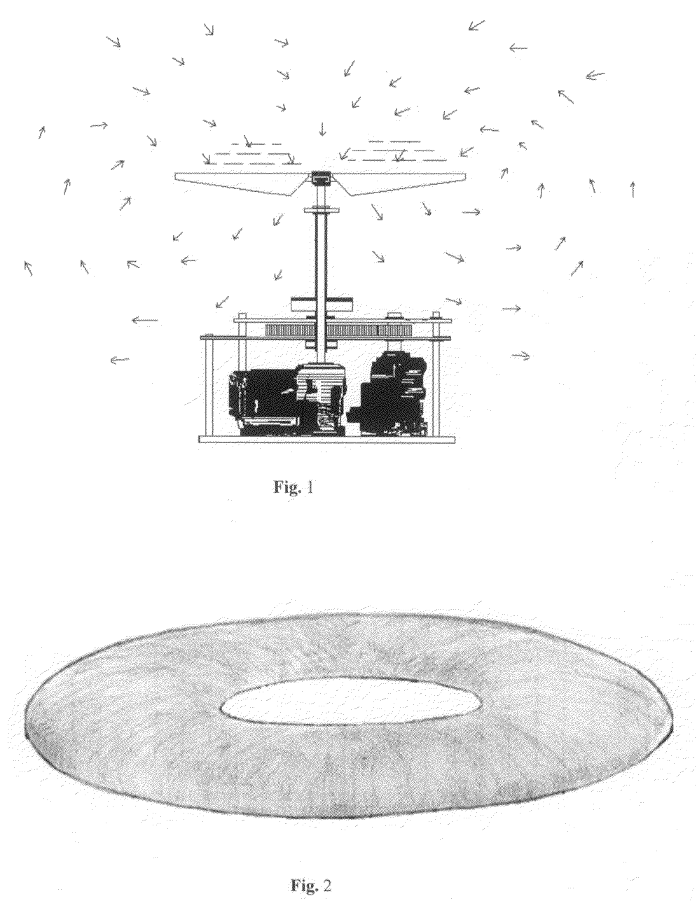

In FIG. 2, a wing configuration as described in paragraph one of this section is depicted, including inner and outer circumferences as well as a concave feature that will facilitate positive control of atmospheric pressure and air flow above and below the wing, and accordingly, lift.

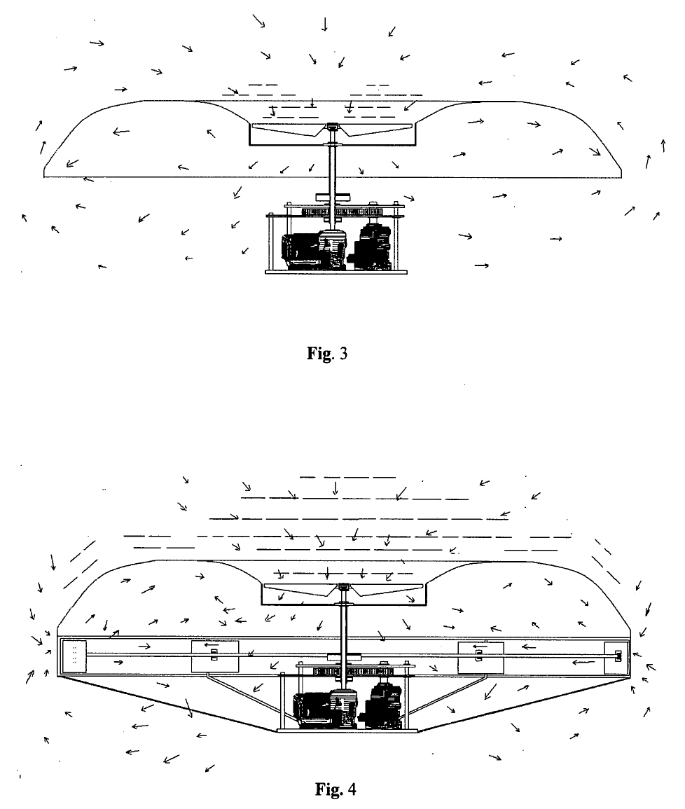

In FIG. 3, examination of the arrows indicate that by establishing the same helicopter like rotor inside the inner circumference of a round wing with an inner circumference, turning it with a positive angle of attack and forcing air/atmosphere downward through 100% of the inner circumference, a low pressure area is created above the rotor blades and the round wing (depicted by the parallel broken lines above the wing and rotor) that is promptly filled by air/atmosphere from beneath the rotor and wing that rushes around the outer circumference of the round wing to fill the aforementioned low pressure area. This phenomenon is similar to conditions created as described in FIG. 1. However, lift can be generated in this manner, but the process is more inefficient than the method depicted in FIG. 1 due to the added weight of the wing.

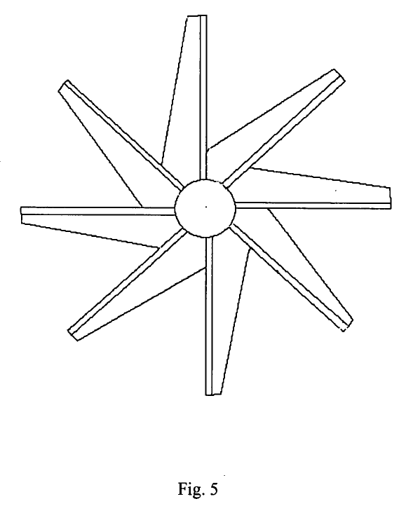

In FIG. 4, by examining the arrows, it can be seen that by establishing the helicopter like rotor or propeller inside the inner circumference of a round wing, turning it with a positive angle of attack and forcing air/atmosphere downward through 100% of the inner circumference, into the area beneath the propeller and wing, a low pressure area is created above the propeller blades and the round wing (as depicted by the broken parallel lines above the wing and propeller). By incorporating an effective means to intercept air/atmosphere forced into the area beneath the propeller and round wing, by the propeller, at all points around the outer circumference of the round wing, as the air/atmosphere attempts to escape and fill the low pressure area above the propeller and wing, the low pressure area above the wing and propeller can be expanded throughout the top surface of the round wing while the atmospheric pressure in the area beneath the round wing and propeller can be forced to increase. Closer examination of FIG. 3 discloses impeller blades with adjustable pitches rotating inside and at the base of the outer circumference of the round wing, that intercept all air/atmosphere in the immediate area of the outer circumference of the wing, and forces the same air/atmosphere inside the area beneath the round wing and propeller, inside the inner circumference of the wing. In this case, the speed and pitch of the propeller and impeller blades regulate the amounts of air flow through the inner circumference of the round wing and past the immediate outer circumference of the round wing, and accordingly, regulate atmosphere and atmospheric pressure above and below the round wing and inner circumference propeller. The round wing and body of the round aircraft will not be unfavorably affected by torque when the propeller blades rotate in a direction opposite from the rotation of the impeller blades. Zero torque will be achieved by adjusting the speed and pitch of each.

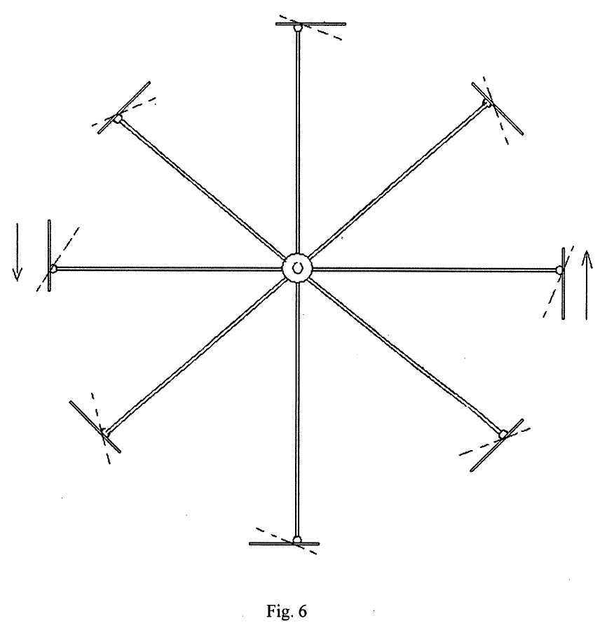

As indicated above, my invention has three primary components including a wing that is also part of the body of the aircraft, that has at least two surfaces, and inner and outer circumferences, hereafter referred to as an O Wing (FIG. 2); a propeller with adjustable pitch propeller blades, hereafter referred to as the Inner Circumference Propeller (FIG. 5); and an impeller assembly with adjustable pitch impeller blades (adjusted positions of increased pitch are represented by the dashed lines), hereafter referred to as the Outer Circumference Impeller Assembly (FIG. 6). These three primary components are further described below.

The O Wing (FIG. 2) is a wing that is of a flattened design, shaped in the form of a wide body O that may be concave, positive, zero or negative, from the outer edge of the outer circumference to the inner edge of the inner circumference. The distance from the outer edge of the outer circumference to the inner edge of the inner circumference; the degrees to which the body of the wing is concave, positive or negative; the diameter of the O wing; and the composition of the O Wing, are each governed by the size and lifting capacity desired or intended for the ALPD.

The Inner Circumference Propeller (FIG. 5) consist of two or more propeller blades, mounted into a propeller shaft head and onto a vertical propeller shaft, that, when mounted, rotates in a field of rotation that is approximately equal in diameter to the diameter of the inner circumference of the O Wing, including the diameter of the propeller shaft head into which the propeller blades are mounted. Each propeller blade is mounted into the propeller shaft head in a manner that will allow each propeller blade to rotate separately so that each propeller blade pitch can be adjusted mechanically and/or electronically, while in motion. The Inner Circumference Propeller shaft onto which the Inner Circumference Propeller (FIG. 5) is mounted may be directly or indirectly driven by a motor or engine, fuel or electric powered, that rotates in a direction opposite the direction of rotation for the Outer Circumference Impeller Assembly (FIG. 6).

The Outer Circumference Impeller Assembly (FIG. 6) consist of two or more Impeller Blades, mounted on the outer ends of horizontal impeller shafts that are attached to a hollow vertical impeller shaft, at equal distances around the horizontal field of rotation, so that when mounted, the impeller blades rotate in a field of rotation that is approximately equal in diameter to the diameter of the outer circumference of the O Wing, including the diameter of the impeller shaft head into which the impeller shafts are mounted. Each impeller blade is mounted onto each horizontal impeller shaft and the impeller shaft head in a manner that will allow adjustment of each impeller blade to increase or decrease each impeller blade pitch, separately, mechanically and/or electronically, while in motion. The hollow vertical impeller shaft onto which the impeller shaft head is mounted is indirectly driven by a motor or engine, fuel or electric powered, that rotates the hollow impeller shaft in a direction opposite the direction of rotation for the Inner Circumference Propeller (FIG. 5).

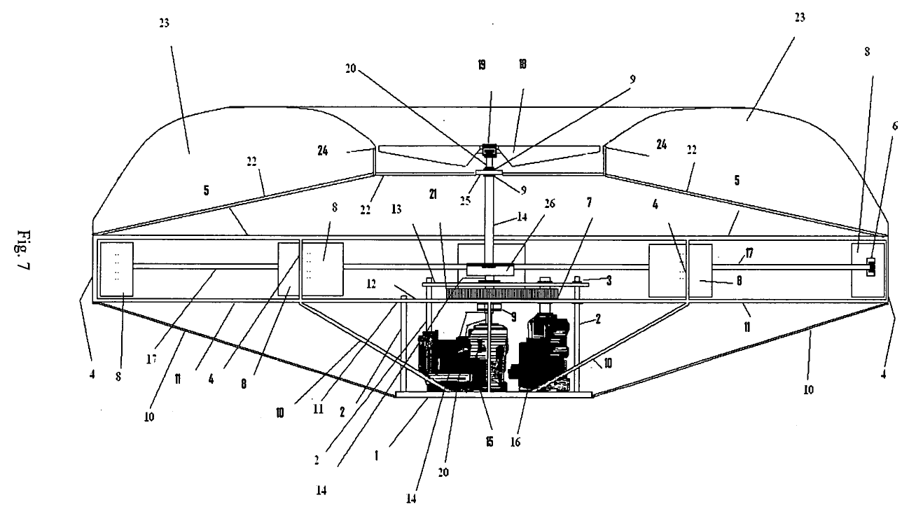

Other components described in this invention that facilitate effective interaction between the above three primary components to create and control lift from a stationary platform include the following (See FIG. 7):
Part 1—Engine Support and Stabilizer Platform
Part 2—Platform Support and Stabilizer Columns
Part 3—Nut and Washer Assembly
Part 4—Connect Bars for Upper and Lower Impeller Intake Framing Members
Part 5—O Wing Outer Circumference Upper Impeller Intake Opening Framing Member
Part 6—Impeller Blade Attachment Assembly
Part 7—Small Vertical Impeller Shaft Gear
Part 8—Impeller Blades
Part 9—Bearing Assembly
Part 10—Support Beams
Part 11—O Wing Outer Circumference Lower Impeller Intake Opening Framing Member
Part 12—Middle Engine and Gear Assembly Support and Stabilizer Platform
Part 13—Upper Gear Support and Stabilizer Platform
Part 14—Vertical Impeller Shaft
Part 15—Engine/Motor I
Part 16—Engine/Motor II (Optional)
Part 17—Horizontal Impeller Shafts
Part 18—Propeller Blades
Part 19—Propeller Shaft Head
Part 20—Propeller Shaft
Part 21—Large Vertical Impeller Shaft Gear
Part 22—Support Beams—Upper Shafts Stabilizer Platform
Part 23—O Wing
Part 24—O Wing Inner Circumference Framing Member
Part 25—Upper Shafts Stabilizer Platform
Part 26—Impeller Shaft Head

The ALPD as set forth in this application, which, when powered, generates lift from a stationary platform using the O Wing (Part 23) in combination with the Inner Circumference Propeller Assembly (FIG. 5) for vertical downward evacuation of air through 100% of the inner circumference of the O Wing (Part 23), into the area beneath the O Wing (Part 23); and an Outer Circumference Impeller Assembly (FIG. 6) for simultaneous horizontal evacuation of air from outside the area of the outer circumference of the O Wing (Part 23), at the outer base of the O Wing (Part 23), into the area beneath the O Wing (Part 23), while maintaining rotational and directional control, is constructed as follows:

The aircraft engine(s) (Parts 15 and 16), O Wing (Part 23), body, Vertical Impeller Shaft (Part 14) and Vertical Propeller Shaft (Part 20) anchor to three flat platforms that are constructed of round, properly hardened sheets of wood, metal, carbon fiber, or another appropriate material, with diameters/widths that may be larger, equal to or less than the diameter/width of the inner circumference of the O Wing (Part 23); and thicknesses that are appropriate to sustain all stresses associated with motion to achieve lift for the completely constructed ALPD and its load.

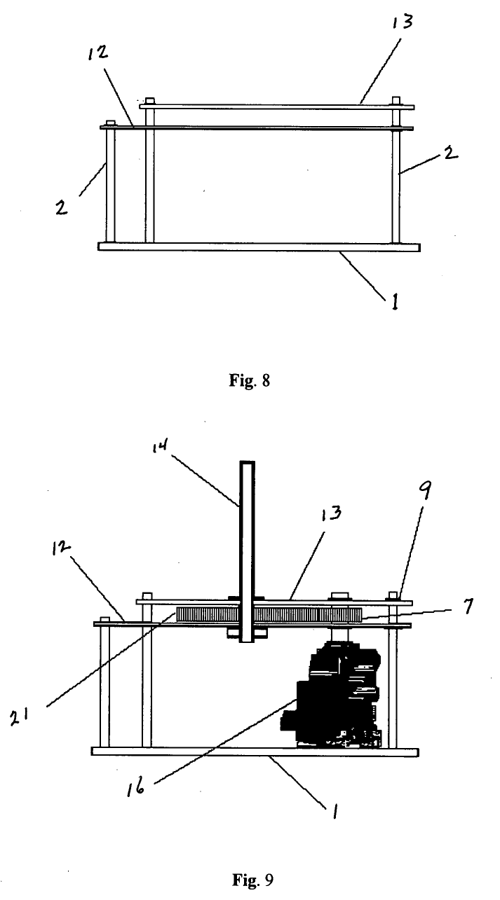

In FIG. 8, the Bottom Engine Support and Stabilizer Platform (Part 1) and the Middle Engine and Gear Assembly Support and Stabilizer Platform (Part 12) have identical dimensions. In this case, the Engine Support and Stabilizer Platform (Part 1) is anchored to the Middle Engine and Gear Assembly Support and Stabilizer Platform (Part 12) with eight aluminum Platform Support and Stabilizer Columns (Part 2) that are equally spaced around the outer circumferences of Bottom Engine Support and Stabilizer Platform (Part 1) and the Middle Engine and Gear Assembly Support and Stabilizer Platform (Part 12). Each is bolted through the Engine Support and Stabilizer Platform (Part 1) and Middle Engine and Gear Assembly Support and Stabilizer Platform (Part 12) at each end of each Platform Support and Stabilizer Column (Part 2). The Upper Gear Support and Stabilizer Platform (Part 13) shares the same dimensions as the Engine Support and Stabilizer Platform (Part 1) and Middle Engine and Gear Assembly Support and Stabilizer Platform (Part 12), except its circumference, in this example, is approximately 25% less that the circumference of the Engine Support and Stabilizer Platform (Part 1) and Middle Engine and Gear Assembly Support and Stabilizer Platform (Part 12). The Upper Gear Support and Stabilizer Platform (Part 13) is also centered and anchored to the top and middle of the Middle Engine and Gear Assembly Support and Stabilizer Platform (Part 12) by an appropriate number of and appropriately lengthened aluminum Platform Support and Stabilizer Columns (Part 2), equally spaced around the outer circumference of the Upper Gear Support and Stabilizer Platform (Part 13), that are bolted through Middle Engine and Gear Assembly Support and Stabilizer Platform (Part 12) and the Upper Gear Support and Stabilizer Platform (Part 13) at each end of each aluminum Platform Support and Stabilizer Columns (Part 2). The Upper Gear Support and Stabilizer Platform (Part 13) may also be offset from the center to accommodate wider or more than two gears in the space between the Upper Gear Support and Stabilizer Platform (Part 13) and the Middle Engine and Gear Assembly Support and Stabilizer Platform (Part 12). In this example, the Upper Gear Support and Stabilizer Platform (Part 13) will be offset from the center of Engine Support and Stabilizer Platform (Part 1) and Middle Engine and Gear Assembly Support and Stabilizer Platform (Part 12).

In FIG. 9, the hollow core Vertical Impeller Shaft (Part 14) is installed through the center opening in the Middle Engine and Gear Assembly Support and Stabilizer Platform (Part 12) and the opening in the Upper Gear Support and Stabilizer Platform (Part 13) that is aligned with the center openings in the Engine Support and Stabilizer Platform (Part 1) and Middle Engine and Gear Assembly Support and Stabilizer Platform (Part 12). An appropriately sized Large Vertical Impeller Shaft Gear (Part 21) to turn the hollow core Vertical Impeller Shaft (Part 14) is mounted on the hollow core Vertical Impeller Shaft (Part 14) between the Middle Engine and Gear Assembly Support and Stabilizer Platform (Part 12) and the Upper Gear Support and Stabilizer Platform (Part 13). An appropriately sized Small Vertical Impeller Shaft Gear (Part 7) is mounted on an appropriately sized shaft between Middle Engine and Gear Assembly Support and Stabilizer Platform (Part 12) and the Upper Gear Support and Stabilizer Platform (Part 13), the same shaft extending upward through the Upper Gear Support and Stabilizer Platform (Part 13), anchored by an appropriate Bearing Assembly (Part 9), and downward through Middle Engine and Gear Assembly Support and Stabilizer Platform (Part 12), anchored by an appropriate Bearing Assembly (Part 9), to a Engine/Motor II (Part 16) that is mounted between the Engine Support and Stabilizer Platform (Part 1) and Middle Engine and Gear Assembly Support and Stabilizer Platform (Part 12). The Engine/Motor II (Part 16) is anchored on the Engine Support and Stabilizer Platform (Part 1). The Small Vertical Impeller Shaft Gear (Part 7) is designed and mounted to turn the Large Vertical Impeller Shaft Gear (Part 21) and the hollow core Vertical Impeller Shaft in a direction opposite from the rotation of the inner circumference propeller assembly, when the Engine/Motor (Part 16) is powered and turns the Smaller Vertical Impeller Shaft Gear (Part 7).

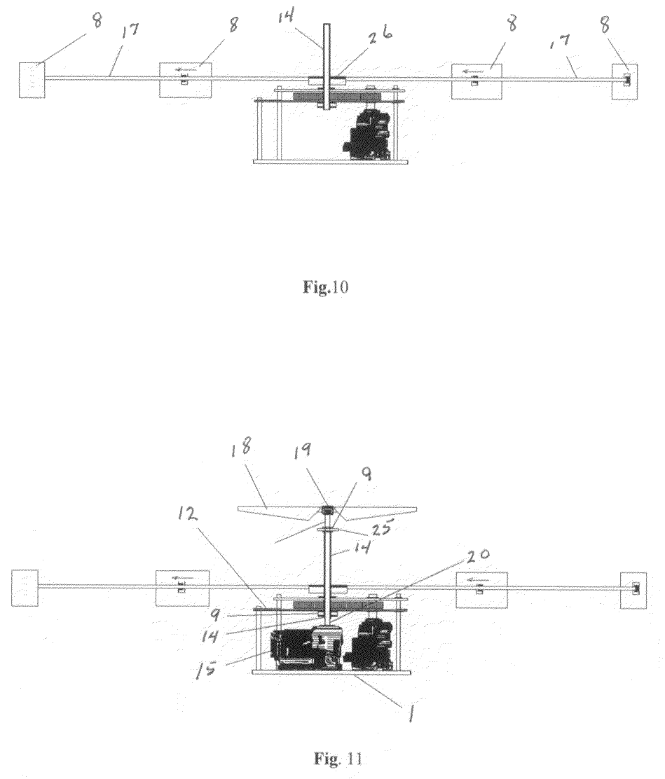

In FIG. 10, two or more appropriately sized Impeller Blades (Part 8) are mounted onto hollow and appropriately sized Horizontal Impeller Shafts (Part 17). The Horizontal Impeller Shafts (Part 17) are then mounted horizontally into the Vertical Impeller Shaft Head (Part 26) which is mounted at or near the top of the vertically mounted hollow Vertical Impeller Shaft (Part 14). In this example, eight Impeller Blades (Part 8) have been installed. A section of the hollow core Vertical Impeller Shaft (Part 14) protrudes through the Vertical Impeller Shaft Head (Part 26) which will anchor into a Bearing Assembly Part 9) mounted beneath the Upper Shafts Stabilizer Platform (Part 25).

In FIG. 11, a solid Vertical Propeller Shaft (Part 20) is mounted directly from Engine/Motor I (Part 15) through an appropriately sized Bearing Assembly (Part 9) mounted beneath the center of the Middle Engine and Gear Assembly Support and Stabilizer Platform (Part 12), through the center of the vertically mounted hollow core Vertical Impeller Shaft (Part 14), beyond the top of the Upper Shafts Stabilizer Platform (Part 25), through an appropriate bearings assembly mounted on the top center of the Upper Shafts Stabilizer Platform (Part 25), centering the Vertical Propeller Shaft (Part 20) inside the hollow core Vertical Impeller Shaft (Part 14) and above the shaft for Engine/Motor I (Part 15). The Vertical Propeller Shaft Head (Parts 19) is attached the Vertical Propeller Shaft (Part 20). The Vertical Propeller Shaft Head (Part 19) is mounted with sufficient clearance from the Upper Shafts Stabilizer Platform (Part 25) to allow for installation of propeller blade pitch controls.

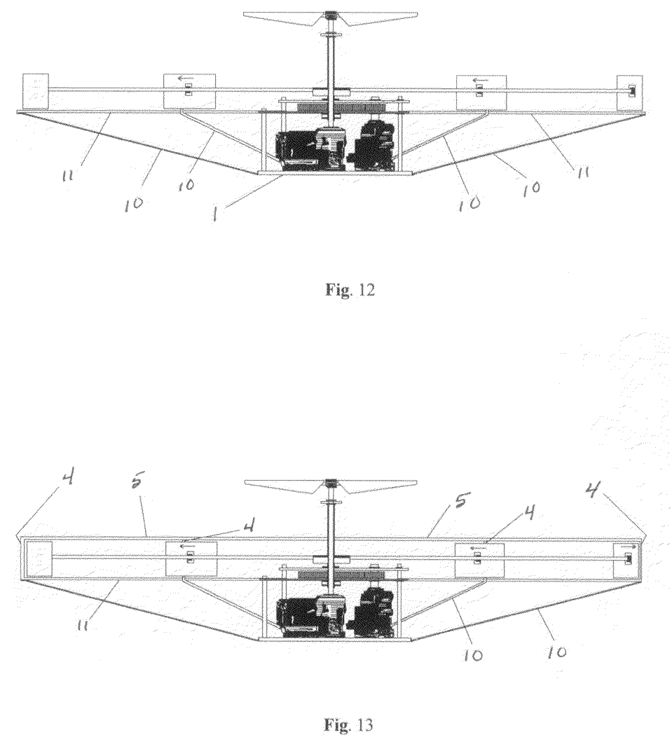

In FIG. 12, the lower frame members are installed, including the O Wing Outer Circumference Lower Impeller Intake Opening Framing Member (Part 11), which is a circular bar, 360 Degrees around the outside of the impeller rotation field, at the base of the outer circumference of the O Wing; and eight Support Beams (Part 10), equally spaced on the O Wing Outer Circumference Lower Impeller Intake Opening Framing Member Part 11), extending downward to the Engine Support and Stabilizer Platform (Part 1), and appropriately attached at each end.

In FIG. 13, mounted to the top of the lower framing members are the O Wing Outer Circumference Upper Impeller Intake Opening Framing Member (Part 5), which is a circular bar, 360 Degrees around the outside of the impeller rotation field, at the base of the outer circumference of the O Wing; and eight Connector Bars (Part 4), appropriately sized and equally spaced between the O Wing Upper and Lower Impeller Intake Opening Framing Members (Parts 5 and 11), and join at points along the circumference that coincide with points where the Support Beams (Part 10), described above, are attached.

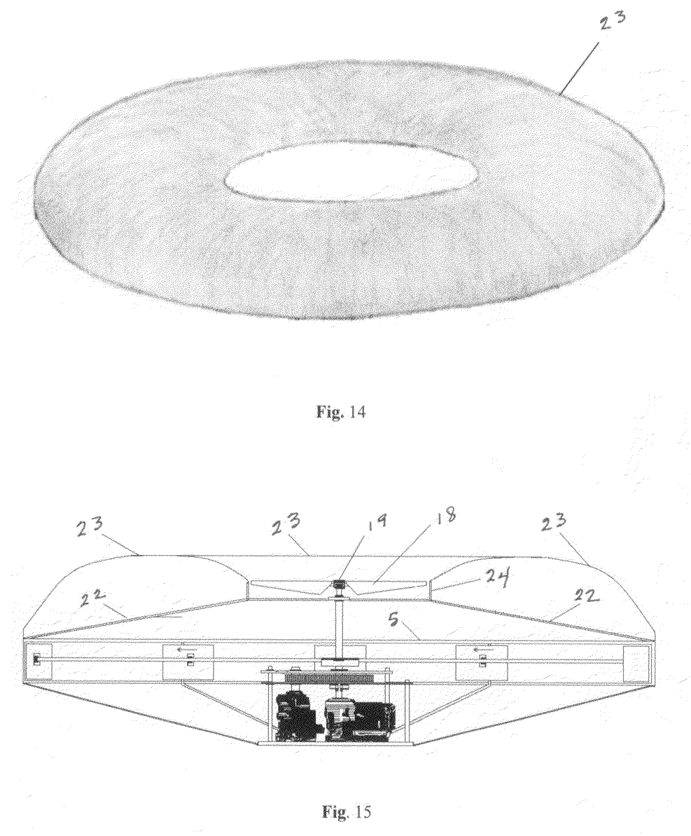

In FIG. 14 the concave O Wing (Part 23) is depicted in 3-dimensional drawing, including display of its concave design with an inner and outer circumference. Its outer circumference is equal to the outer circumference of the O Wing Upper Impeller Intake Opening Framing Member (Part 5), and is designed to fit on top of the same. The inner circumference is designed to serve as the outer boundary for the Inner Circumference Propeller Assembly (Parts 18 and 19) rotation field.

In FIG. 15, the O Wing (Part 23) is mounted to the O Wing Outer Circumference Upper Impeller Intake Opening Framing Member (Part 5), around the rotation field for the Propeller Assembly (Parts 18 and 19); p and attached to the Support Beams (Part 22) for the Upper Shafts Stabilizer Platform (Part 25) and the O Wing Inner Circumference Framing Member (Part 24).

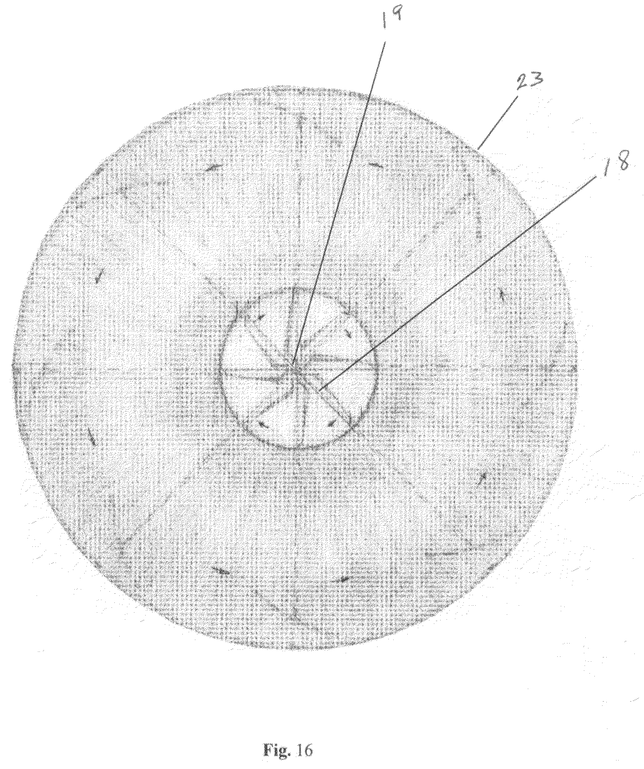

In FIG. 16, a top view of the ALPD is shown depicting the top portion of the O Wing (Part 23) and the inner circumference Propeller Assembly (Parts 18 and 19)

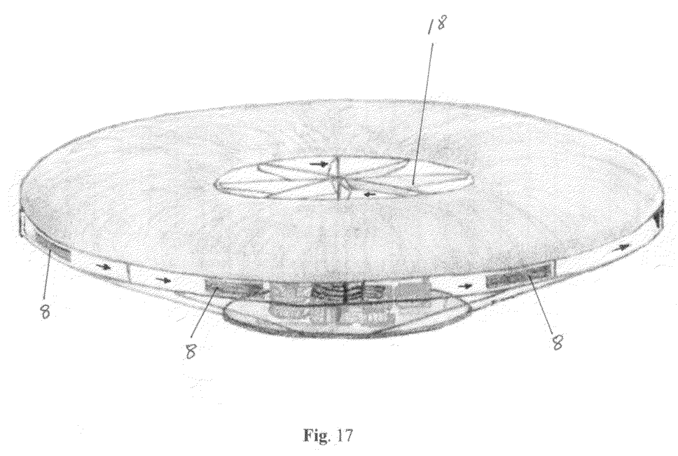

In FIG. 17 a three dimensional image depicts a basic assembled ALPD with the Propeller Blade Assembly (Parts 18 and 19) rotating in a clockwise direction while the Impeller Assembly (Parts 6, 8, and 17) rotate in a counterclockwise direction. These combined actions in combination with the design of the O Wing enable the ALPD to lift from it stationary position and maintain controlled flight.

1. I claim as my invention any wing, wing design, blade, item or object, with at least two surfaces, and an inner and outer circumference, inclusive of any portion of a body, frame, or framing member, that is used to create and/or generate lift by developing and/or increasing or decreasing a difference in the atmospheric pressure, amount of atmosphere, amount of vacuum, and/or the amount of air, that exist above and below the same stationary or non stationary wing, blade, item or object, or its upper and/or lower surfaces, or its opposite surfaces, by mechanical or other means, not including lift created by the linear or rotary motion of the same wing, blade, item, or object.

2. I claim as my invention the employment, use, or application of any mechanical or other means to remove, evacuate, draw, or redirect atmospheric pressure, amounts of atmosphere, amounts of vacuum, and/or amounts of air, from the upper surface of any stationary or non-stationary wing, blade, item or object, with at least two surfaces, and an inner and outer circumference, inclusive on any portion of a body, frame or other structural member, to an area beneath the lower or opposite surface, past or through any or all points around the outer circumference and any or all points within the inner circumference, simultaneously or not, including all ranges of positive and negative flows, not including removal, evacuation, drawing or redirecting atmospheric pressure, amounts of atmosphere, amounts of vacuum, and/or amounts of air, by linear or rotary movement of the same wing, blade, item or object.

3. I claim as my invention the employment, use, or application of one or more propellers and impellers, in combination with a wing, blade, item or object, with at least two surfaces, and an inner and outer circumference, inclusive of any portion of a body, frame, or framing member, to create and/or generate lift by developing and/or increasing or decreasing a difference in the atmospheric pressure, amount of atmosphere, amount of vacuum, and/or the amount of air, that exist above and below the same stationary or non stationary wing, blade, item or object, or its upper and lower surfaces, or its opposite surfaces, not including lift created by the linear or rotary motion of the same wing, blade, item, or object.

4. I claim as my invention pitch adjustable impellers on a common propeller head that, with rotation, move atmospheric pressure, amounts of atmosphere, amounts of vacuum, and/or amounts of air laterally into or out of the circumference of the same rotation field, at varying rates, depending on the rate of rotation and/or the adjusted pitch of each impeller blade or the adjusted angle of attack for each impeller blade.

5. I claim as my invention an air craft design or aerial lifting and propulsion device that achieves lift and flight through the use of a propeller, an impeller, and a circular wing to creates and/or generates lift by developing and/or increasing or decreasing a difference in the atmospheric pressure, amount of atmosphere, amount of vacuum, and/or the amount of air, that exist above and below the same circular wing, by a mechanical means as set forth in claims I, II, and III, above, in which all moving parts are located inside all exterior planes of the aircraft or mechanical aerial lifting and propulsion device, and does not require the lateral movement of a wing or singular rotary motion of a propeller to achieve lift.
